(19) United States
(12) Patent Application Publication
(10) Pub. No.: US 2009/0294432 A1
(43) Pub. Date: Dec. 3, 2009

(54) COOKTOP, HEATER SUPPORT DEVICE OF COOKTOP, AND HEATER SUPPORT SPRING OF COOKTOP

(76) Inventor: Yun-Geon Baek, Changwon-Si (KR)

Correspondence Address: BIRCH STEWART KOLASCH & BIRCH, PO BOX 747, FALLS CHURCH, VA, 22040-0747, US

(21) Appl. No.: 12/300,103

(22) PCT Filed: May 9, 2007
(86) PCT No.: PCT/KR07/02279

§ 371 Date: Mar. 23, 2009

(30) Foreign Application Priority Data
May 11, 2006 (KR) 10-2006-0042442

(51) Int. Cl. H05B 3/68

(52) U.S. Cl. 219/448.11; 219/461.1

(57) ABSTRACT

A cooktop is provided. The cooktop includes, a main machine, at least one heater disposed inside the main machine, a temperature sensor for measuring a temperature of the heater, a fixing member formed in the main machine, a top glass disposed on the upper side of the main machine, and a heater support spring for supporting the heater. The heater is provided with a bracket. The heater support spring is fixed to the main machine using the fixing member, caught and supported at the heater by the bracket to seat and elastically support the heater, and limit rotation of the heater.

### TECHNICAL FIELD

The present invention relates to a cooktop, and more particularly, to a heater support structure of a cooktop, and a heater support spring of a cooktop that increase assembling efficiency between a main machine and a heater.

### BACKGROUND ART

Generally, a cooktop is a cooking appliance for delivering high heat generated from an electronic heat member to a heating portion of a top glass to cook food. Here, a temperature of the heat member that is applied to the heating portion is about 500-600° C. The top glass is formed of tempered glass so that it is not easily destroyed by external impact. Also, four or five heating portions of the top glass are provided to a predetermined position according to the standard of the cooktop. One or two of the heating portions have a greater or smaller diameter than those of other heating portions to correspond to the standard of the cooking appliance.

An electric heater provided as a heat source to the heating portions of the top glass includes an electric heat coil installed inside a container formed of a ceramic material, and a temperature sensor attached to the container to sense heating temperature of the heat coil.

A related art cooktop includes a main machine, a heater received inside the main machine, and a top glass provided to cover the upper surface of the main machine. Here, the heater is fixed and installed on the main machine such that the upper surface of the heater contacts the lower surface of the top glass.

For mutual contact and support of the heater and the top glass, a fixing member fixed on the main machine, and a separate heater support spring are coupled to each other after the heater support spring is coupled to the heater, so that the heater is fixed. After that, the top glass is disposed on the heater. Since the top glass pressurizes the heater toward the upper direction of the heater, contact between the heater and the top glass is maintained.

However, according to the related art cooktop having the above-described construction, not only a defect rate increases but also assembling efficiency decreases during a process of assembling the heater to the main machine.

In detail, when the heater support spring is fixed to the heater using screws, it is fixed with the heater turned upside down. During the fixing process, the coil installed to the heater is simply fit on the upper surface of the heater without a separate fixing element.

Accordingly, when the heater support spring is fixed to the heater with the heater turned upside down, the heat coil is easily separated from the heater.

The problem is not limited to a defect rate generated due to separation of the heat coil from the heater, but includes a problem that injures an operator's health. In other words, when the heater is turned upside down, dusts generated while the heat coil is separated from the heater, and powder generated when the heater support spring is assembled using the screws is introduced to the operator's respiratory organ to generate respiratory ailments and skin ailments.

Also, during a process of assembling the heater to the main machine, the heater support spring is coupled to the heater using the screws, and the heater is coupled to the main machine. Accordingly, the operator should couple the screws one by one during the assembling process, which decreases assembling efficiency.

### DISCLOSURE OF INVENTION

### Technical Problem

An object of the present invention is to provide a cooktop that improve productivity through an increase in assembling efficiency by simplifying assembling of a heater and a main machine.

Another object of the present invention is to provide a cooktop that can simply assembling of a heater to a main machine to improve productivity while minimizing a defect rate of the heater by seating the heater on a heater support spring after coupling the heater support spring to a fixing member when fixing the heater to the main machine.

Still another object of the present invention is to provide a cooktop that can improve a working environment by allowing a heater to be fixed without turning the heater upside down and coupling the heater using screws.

### Technical Solution

According to one aspect of the present invention, there is provided a cooktop having a main machine, at least one heater disposed inside the main machine, a temperature sensor for measuring a temperature of the heater, a fixing member formed in the main machine, a top glass disposed on the upper side of the main machine, and a heater support spring for supporting the heater, the cooktop including: a bracket installed in the heater, wherein the heater support spring is fixed using the fixing member, caught and supported by the bracket to seat and elastically support the heater, and limit rotation of the heater.

In another aspect of the present invention, there is provided a heater support tool including: a heater disposed inside a main machine; a top glass disposed on an upper side of the main machine; and at least one heater support spring supporting the heater by pushing the heater toward the top glass, wherein the heater support spring includes an installation member firmly coupled to the main machine using a predetermined coupling member, elastically supporting a lower side and a lateral side of the heater, and is installed in the heater caught and supported by the heater support spring to prevent rotation of the heater.

In further another aspect of the present invention, there is provided a heater support spring of a cooktop that is interposed between a main machine and a heater to support the heater, and has a base fixed in the main machine, and an elastic piece extending from the base to support a lower side of the heater, the heater support spring including a side support extending perpendicularly from the base to support an outer side of the heater, wherein the side support catches a portion of the heater to prevent rotation of the heater.

According to the present invention, convenience in assembling a heater improves, a defect is prevented while a heater is assembled, and a surrounding working environment where a heater is assembled improves.

### Advantageous Effects

According to the present invention, convenience in assembling a heater improves, a defect is prevented while a heater is assembled, and a surrounding working environment where a heater is assembled improves.

### BRIEF DESCRIPTION OF THE DRAWINGS

The present invention is clearly understood by referring to the accompanying drawings, in which:

FIG. 1 is an exploded perspective view of a cooktop according to the present invention;

FIG. 2 is an enlarged view of a cooktop of the portion A of FIG. 1;

FIG. 3 is an enlarged perspective view of a heater support spring according to the present invention; and

FIG. 4 is a lower perspective view of an installed heater support spring according to the present invention.

### BEST MODE FOR CARRYING OUT THE INVENTION

Reference will now be made in detail to the preferred embodiments of the present invention, examples of which are illustrated in the accompanying drawings.

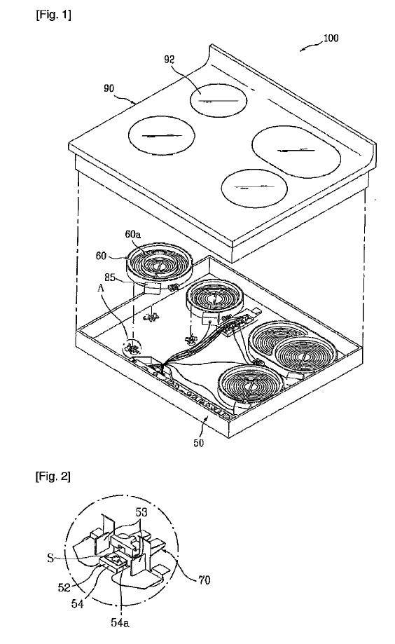

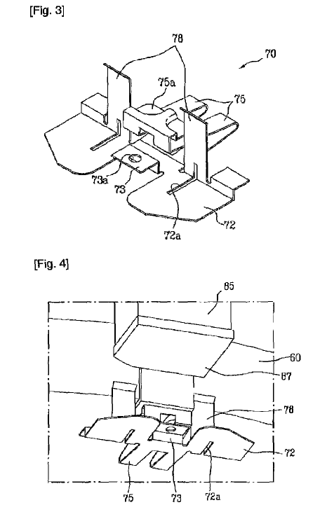

FIG. 1 is an exploded perspective view of a cooktop according to the present invention, FIG. 2 is an enlarged view of a cooktop of the portion A of FIG. 1, and FIG. 3 is an enlarged perspective view of a heater support spring according to the present invention.

Referring to FIGS. 1 to 3, the cooktop 100 includes a main machine 50, heaters 60 received inside the main machine 50, a top glass 90 for covering the upper side of the main machine 50. The cooktop 100 heats a cooking instrument to cook food.

The main machine 50 is formed in a box shape having an open top. A plurality of electric cables and devices for heat emission of the heaters 60 are installed inside the main machine 50. Also, the same number of fixing members 52 as that of the heaters 60 are installed in the main machine 50. The plurality of fixing members 52 are arranged to correspond to positions of the heaters 60 installed inside the main machine 50, respectively.

As described above, the fixing members 52 can be formed by cutting portions of the main machine 50. The cut portions include a pair of guides 53, and a bending part 54 located between the guides 53 and having a coupling hole 54a. When the fixing member 52 is formed in the main machine 50, a heater support spring 70 for limiting movement of the heaters 60 and stably supporting the heaters 60 is coupled to the fixing member 52.

The heater support spring 70 includes a base 72, elastic pieces 75, and a pair of side supports 78. Here, the elastic pieces 75 support the lower side of the heater 60, and can be named as a lower support. The side supports 78 support the lateral sides of the heater 60.

Silts 72a into which the guides 53 of the fixing member are fitted are formed in the base 72. As the guides 53 of the fixing members are formed in a pair, the slits 72a are provided in a pair to correspond to the pair of the guides 53. Also, a fixing piece 73 plane-contacting the bending part 54 of the fixing member is formed between the slits 72a. A coupling hole 73a having the same measure as that of the coupling hole 54a of the fixing member is formed in the center of the fixing piece 73.

Therefore, the heater support spring 70 is coupled to the fixing member 52 in the following way. When the guides 53 of the fixing member are fit in the slits 72a of the heater support spring, the bending part 54 of the fixing member closely contacts the fixing piece 73 of the heater support spring while they plane-contact each other. At this state, a screw S is coupled to pass through a pair of coupling holes 54a and 73a.

Also, the elastic pieces 75 for elastically supporting the lower side of the heater 60 extends from the base 72. The elastic pieces 75 have a shape where the central portion of portions extending from the base 72 are bent such that inner sides of the extending portions face each other. Also, a screw receiving groove 75a for receiving a screw that can be installed in the lower surface of the heater 60 is formed at the front end of the elastic piece 75.

Also, the side supports 78 for restricting horizontal movement of the heater 60 is bent from the base 72. The slits 72a of the base 72 extend to the side supports 78 to allow the guides 53 to be simultaneously fitted in the side supports 78 when the guides 53 are fitted in the base 72.

Also, the side supports 78 are located on the same line as the front end of the elastic piece 75, and can be located both sides of the front end of the elastic piece 75. That is, the side supports 78 are located on the same line as that of the front end of the elastic piece 75 to allow the outer side of the heater 60 to maintain a closely contacting state with respect to the side supports 78 when the heater 60 is disposed on the elastic piece 75.

At this point, though the heater 60 can be formed in various shapes, description is restricted to the circle-shaped heater 60.

A heat coil 60a is installed on the upper side of the heater 60. A temperature sensor 85 is installed on the periphery of the heater 60 using a bracket 87 shown in FIG. 4. The bracket 87 is fixed on the periphery of the heater 60 using a screw (not shown), and the screw is received in the screw receiving groove 75a of the elastic piece.

Also, the top glass 90 is closely attached on the upper side of the heater 60 and coupled to the main machine 50. Here, the top glass 90 is formed of a ceramic flat plate, and includes a plurality of heating portions 92 forming a predetermined arrangement. The top glass 92 is provided to correspond the number and arrangement of the heaters 60, and can be formed of tempered glass.

FIG. 4 is a lower perspective view of a heater to which a heater support spring has been coupled. A heater support tool of a cooktop according to the present invention will be described in detail with reference to FIGS. 3 and 4.

To assemble a cooktop according to the present invention on an assembling line, the heater support spring 70 is coupled to the fixing member 52 installed in the main machine 50. Of course, the fixing member 52 and the heater support spring 70 are coupled to each other using a screw S. Also, the guides 53 are fitted in the slits 72a before the heater support spring 70 is coupled to the fixing member 52, so that an assembling process is conveniently performed as described above.

After the heater support spring 70 is coupled to the fixing member 52, the heater 60 is seated on the elastic piece 75 of the heater support spring 70 is seated.

In detail, when the heater 60 is seated on the heater support spring 70, the outer peripheral surface of the heater 60 is closely attached on the inner surfaces of the side supports 78. Accordingly, horizontal movement of the heater 60 is restricted by the side supports 78.

Also, when the heater 60 is seated on the heater support springs 70, the bracket 87 of at least one of the heater support springs 70 is fitted between a pair of the side supports 78. In other words, the bracket 87 and the side supports 78 have a position relation where they are caught and supported by each other. Here, the bracket 87 is designed for supporting the temperature sensor 85 as described above.

The bracket 87 is installed between a pair of side supports 78 such that they are caught and supported by each other to prevent the heater 60 from rotating or moving against external impact or while it is carried. In other words, there exist only the elastic piece 75 and the side supports 78 severing as a medium for connecting the heater support springs 70 with the heater 60 while the heater 60 is seated on the heater support springs 70. Accordingly, when an impact is applied to the heater 60, there is a high possibility that the heart 60 rotates. To solve the problem that the heater 60 rotates, the bracket 87 is fitted between a pair of the side supports 78, so that rotation or horizontal movement of the heater 60 can be naturally limited.

Also, since the side supports 78 contacting the periphery of the heater 60 are coupled to a pair of the guides 53, the side supports 78 stably support the periphery of the heater 60 to minimize movement of the heater 60.

After heater 60 is seated on the heater support spring 70, the top glass 90 is coupled to the main machine 50 while it applies force on the upper side of the heater 60 to some extent. Therefore, the heater 60 is pressurized to some extent between the top glass 90 and the main machine 50, and simultaneously, the bracket 87 is fitted between the side supports 87 of the heater support springs 70, so that movement, particularly, rotation of the heater 60 can be effectively restricted.

Accordingly, since the heater support springs 70 firmly support the heater 60 even when external impact is applied to the cooktop 100, or while the cooktop 100 is carried, a damage that can be generated to the heater 60 can be minimized, and durability increase can be expected.

Meanwhile, the bracket 87 is designed for supporting the temperature sensor. One bracket 87 is provided to one heater 60. Therefore, the screw receiving groove 75a may be formed in only one of the heater support springs and may not be formed in the other heater support spring. The screw receiving groove 75a is not limited thereto, but all of the heater support springs may be provided with the screw receiving groove 75a in order to remove difficulty in separately forming different kinds of heater support springs. For other case, a separate bracket 87 can be provided to other position where the temperature sensor is not provided for the purpose of supporting the heater support spring 70 as well as the temperature sensor to more firmly support the heater 60. However, since the heater support springs are provided to three positions as shown in the drawing, the heater 60 can be properly supported even when the separate bracket 87 is not provided.

Also, it is more preferable that the bracket 87 is provided for fixing the temperature sensor because a separate part is not consumed, the bracket 87 is not limited thereto. That is, the temperature sensor can be fixed for itself, and another bracket can be separately further provided for preventing rotation and movement of the heater support spring. Further, the bracket can be provided in a predetermined shape integrally on the outer surface of the heater, and can be separately provided on the outer surface of the heater.

Also, though the plurality of heater support springs are provided, other portion can be supported by other type of a heater support spring, and at least one portion can be supported by the heater support spring according to the present invention.

Also, the heater support spring can be installed not only to allow the upper side of the main machine to approach the top glass completely sealing the upper side of the main machine, but also to support the heater with a predetermined portion of the top glass opened.

According to the cooktop of the present invention, the screw coupling process is simply performed one time while the heater is coupled to the main machine, a defective heater is not manufactured, and productivity can be improved through an increase in assembling efficiency. Also, the heater can be fixed without turning the heater upside down and coupling screws, which can improve a working environment.

Further, the heater is not rotated and can be stably supported by the heater support spring.

It will be apparent to those skilled in the art that various modifications and variations can be made in the present invention. Thus, it is intended that the present invention covers the modifications and variations of this invention provided they come within the scope of the appended claims and their equivalents.

1. A cooktop having a main machine, at least one heater disposed inside the main machine, a temperature sensor for measuring a temperature of the heater, a fixing member formed in the main machine, a top glass disposed on the upper side of the main machine, and a heater support spring for supporting the heater, the cooktop comprising:
a bracket installed in the heater,
wherein the heater support spring is fixed using the fixing member, caught and supported by the bracket to seat and elastically support the heater, and limit rotation of the heater.

2. The cooktop according to claim 1, wherein the fixing member comprises:
a pair of guides in which the heater support spring is fitted; and
a bending part located between the guides and having a screw coupling hole.

3. The cooktop according to claim 1, wherein the heater support spring comprises:
a base provided with slits for receiving a pair of the guides, and provided at a central portion with a fixing piece for plane-contacting the bending part of the fixing member;
an elastic piece extending from the base to elastically support a lower side of the heater; and
a pair of side supports perpendicularly bent from the base, for receiving the guides and simultaneously restricting horizontal movement of the heater.

4. The cooktop according to claim 1, wherein the bracket is provided to install the temperature sensor to the heater.

5. The cooktop according to claim 1, wherein the bracket is located between a pair of side supports formed at the heater support spring to restrict rotation of the heater.

6. A heater support tool comprising:
a heater disposed inside a main machine;
a top glass disposed on an upper side of the main machine; and
at least one heater support spring supporting the beater by pushing the heater toward the top glass,
wherein the heater support spring comprises an installation member firmly coupled to the main machine using a predetermined coupling member, elastically supporting a lower side and a lateral side of the heater, and is installed in the heater caught and supported by the heater support spring to prevent rotation of the heater.

7. The heater support tool according to claim 6, further comprising a temperature sensor provided to the heater to measure temperature, wherein the installation member fixes the temperature sensor to the heater.

8. A heater support spring of a cooktop that is interposed between a main machine and a heater to support the heater, and has a base fixed in the main machine, and an elastic piece extending from the base to support a lower side of the heater, the heater support spring comprising:
a side support extending perpendicularly from the base to support an outer side of the heater,
wherein the side support catches a portion of the heater to prevent rotation of the heater.

9. The heater support spring according to claim 8, wherein a slit is formed in the base to receive a guide formed at the main machine to allow the heater support spring to be accurately located.

10. The heater support spring according to claim 8, wherein a pair of side supports is provided, and the portion of the heater is fitted between the side supports.

11. The cooktop according to claim 2, wherein the heater support spring comprises:
a base provided with slits for receiving a pair of the guides, and provided at a central portion with a fixing piece for plane-contacting the bending part of the fixing member;
an elastic piece extending from the base to elastically support a lower side of the heater; and
a pair of side supports perpendicularly bent from the base, for receiving the guides and simultaneously restricting horizontal movement of the heater.
